(19) United States
(12) Patent Application Publication
(10) Pub. No.: US 2005/0241508 A1
(43) Pub. Date: Nov. 3, 2005

(54) Guide system for forming ink images

(76) Inventor: Jeffrey M. Winston, Anacortes, WA (US)

Correspondence Address: SCHACHT LAW OFFICE, INC., SUITE 202, 2801 MERIDIAN STREET, BELLINGHAM, WA, 98225-2412, US

(21) Appl. No.: 11/118,859

(22) Filed: Apr. 29, 2005

Related U.S. Application Data
(60) Provisional application No. 60/567,015, filed on Apr. 29, 2004.

(51) Int. Cl. B41K 1/42

(52) U.S. Cl. 101/327; 101/481

(57) ABSTRACT

An inking system for forming an ink image on an inking surface, comprising a guide system and an inking assembly. The guide system defines at least one side edge surface and is arranged in a desired orientation on the inking surface. The inking assembly is used to form an ink image on the inking surface. In particular, the at least one side edge surface of the guide system is sized and dimensioned to engage the at least one inking assembly such that the ink image is formed at a desired location on the inking surface.

### RELATED APPLICATIONS

This application claims priority of U.S. Provisional Patent Application Ser. No. 60/567,015 filed Apr. 29, 2004.

### FIELD OF THE INVENTION

The present invention relates to systems and methods for forming ink images and, more specifically, guide systems for facilitating the formation of ink images with conventional flat and continuous inking assemblies.

### BACKGROUND OF THE INVENTION

The present invention relates ink stamping systems and methods in which an ink impression is formed on an image surface. The ink is applied to a stamp member on which a design is formed in bas relief. The stamp member with ink thereon is brought into contact with the image surface such that ink is transferred to the image surface to form an ink impression or image in a configuration corresponding to the design on the stamp member.

The present invention is of particular importance in the formation of artistic rather than commercial ink impressions. Art stamping uses the same basic ink stamping process as commercial ink stamping but has evolved to allow more precise creative control over the details and quality of the resulting ink impression. The principles of the present invention may also have application to commercial ink stamping, however.

Ink stamping systems for use by art stampers are designed and constructed primarily to obtain a high quality ink impression, with flexibility of use also being of importance. Considerations such as repeatability of the ink impression, ease of use, and durability of the stamping devices are of lesser importance than in the commercial ink stamping environment.

In one conventional form, an inking assembly comprises a stamp member formed by flat sheet of rubber. A design formed in bas relief on a first surface of the stamp member. A second surface of the stamp member is typically supported by a rigid member, sometimes with a handle that facilitates manipulation of the stamp member.

Continuous inking assemblies that form a continuous, repeated ink image are also known. Such inking assemblies comprise a stamping wheel that supports a stamp member defining a cylindrical stamping surface. The design formed in bas relief on the stamp member is formed on the outer surface of the stamp member. The stamp member is mounted on a handle or handle assembly such that the handle can be grasped to roll the stamp member along an ink pad and then along an inking surface to form the desired ink impression on the inking surface. In some continuous inking assemblies, the ink pad is also mounted to the handle such that ink is continuously applied to the outer member of the stamp member as the stamp member rolls along the inking surface.

The need exists for improved systems and methods for creating ink impressions utilizing one or both of flat inking assemblies and continuous inking assemblies.

### SUMMARY OF THE INVENTION

The present invention may be embodied as an inking system or method for forming an ink image on an inking surface comprising a guide system and an inking assembly. The guide system defines at least one side edge surface and is arranged in a desired orientation on the inking surface. The inking assembly is used to form an ink image on the inking surface. In particular, the at least one side edge surface of the guide system is sized and dimensioned to engage the at least one inking assembly such that the ink image is formed at a desired location on the inking surface.

### DESCRIPTION OF THE DRAWINGS

FIG. 1 is a top plan view of an inking system comprising a guide system and continuous inking assembly;

FIG. 2 is a side elevation view of the inking system of FIG. 1;

FIG. 3 is a cut-away view taken along lines 3-3 in FIG. 1;

FIG. 4 is a top plan view of the guide system depicted in FIG. 1;

FIG. 5 is a side elevation view of the guide system of FIG. 4;

FIGS. 6-7 are cutaway views taken generally along lines 6-6 in FIG. 4 illustrating the engagement of first and second attachment portions of the guide system of FIG. 4;

FIG. 8 is a cutaway view taken along lines 8-8 in FIG. 4 further illustrating the engagement of the first and second attachment portions of the guide system of FIG. 4;

FIGS. 9 and 10 are top plan views of first and second alternate configurations of the guide system of FIG. 1;

FIG. 9A is a side elevation view depicting a fourth, storage configuration, of the guide system as shown in FIG. 9;

FIGS. 11 and 12 are top plan views depicting another inking system comprising a guide system, a continuous inking assembly, and masking sheets;

FIGS. 13 and 14 are top plan views depicting another inking system comprising a guide system, a continuous inking assembly, and masking sheets;

FIGS. 15-18 are top plan views depicting an inking system comprising a guide system, a continuous inking assembly, masking sheets, and a masking strip;

FIGS. 19-22 are top plan views depicting an inking system comprising a guide system, a continuous inking assembly, masking sheets, and a masking strip;

FIG. 23 is a top plan view depicting an inking system comprising a guide system and lined masking sheets;

FIG. 24 is a top plan view depicting an inking system comprising a guide system and flat inking assemblies;

FIGS. 25-28 are top plan views depicting another example method of using an inking system comprising a guide system, a continuous inking assembly, and masking sheets;

FIG. 29 is a top plan view depicting a guide system that may be used in three different configurations; and

FIG. 30 is a top plan view depicting a guide system that may be used in five different configurations.

### DETAILED DESCRIPTION OF THE PREFERRED EMBODIMENTS

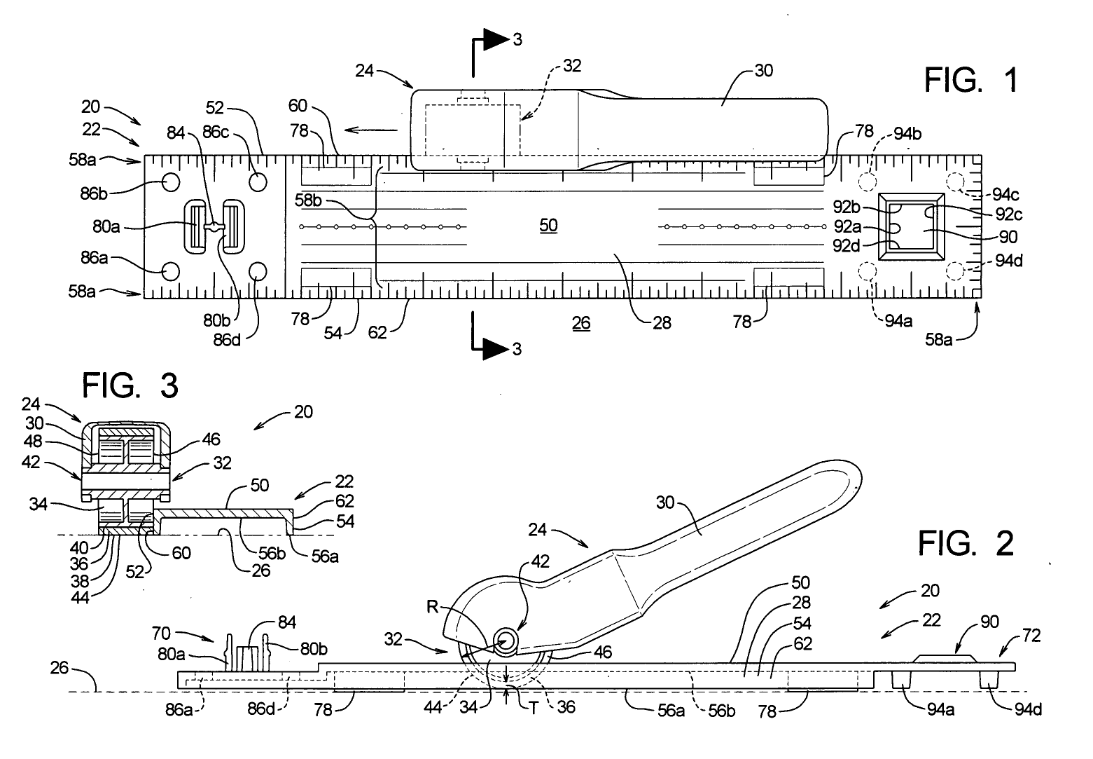

Referring initially to FIG. 1, depicted at 20 therein is a stamping system constructed in accordance with, and embodying, the principles of the present invention. The stamping system 20 comprises a guide system 22 and an inking assembly 24 and is used to form ink images on a printing surface 26. The guide system 22 may comprise one or more guide members 28 as shown.

In use, the guide system 22 is laid on the printing surface 26 at a ruler location adjacent to a desired location at which an ink image is to be formed. The inking assembly 24 is then placed on the printing surface 26 within the desired location and adjacent to the guide system 22. The inking assembly 24 is then displaced along the printing surface 26 within the desired location to apply ink to the printing surface in the desired location. The inking assembly 24 is held against the guide system 22 such that the guide system 22 guides the inking assembly 24 along a substantially straight inking path to form the image at the desired location.

The inking assembly 24 is not per se part of the present invention and will be described herein only to the extent necessary for a complete understanding of the present invention. The example inking assembly 24 is or may be a conventional inking assembly comprising a handle assembly 30 and a wheel assembly 32. The wheel assembly 32 comprises a hub member 34 and a stamp member 36. The hub member 34 defines a substantially cylindrical stamp surface 40 and a hub portion 42 aligned with the axis of the support surface 40. The hub portion 42 engages the handle assembly 30 such that the wheel assembly 32 rotates relative to the handle assembly 30.

As is conventional, the example inking assembly 24 may further comprise an ink cartridge (not shown) that continuously applies ink to the stamp member 36 as the stamp member 36 moves relative to the handle assembly 30. Alternatively, the inking assembly 24 may not include an ink cartridge, in which case a user may grip the handle assembly 30, roll the wheel assembly 32 along an ink pad, and then roll the wheel assembly 32 along the inking surface 44.

The wheel assembly 32 defines first and second side surfaces 46 and 48. The side surfaces 46 and 48 are formed by the edge portions of the hub member 34 and the stamp member 36. The side surfaces 46 and 48 are generally annular and substantially parallel with each other. The portion of the example side surfaces 46 and 48 formed by the stamp member 36 has a radial thickness dimension indicated by reference character T; the side surfaces 46 and 48 define an outer radius dimension of the wheel assembly 32 indicated by reference character R in FIG. 2.

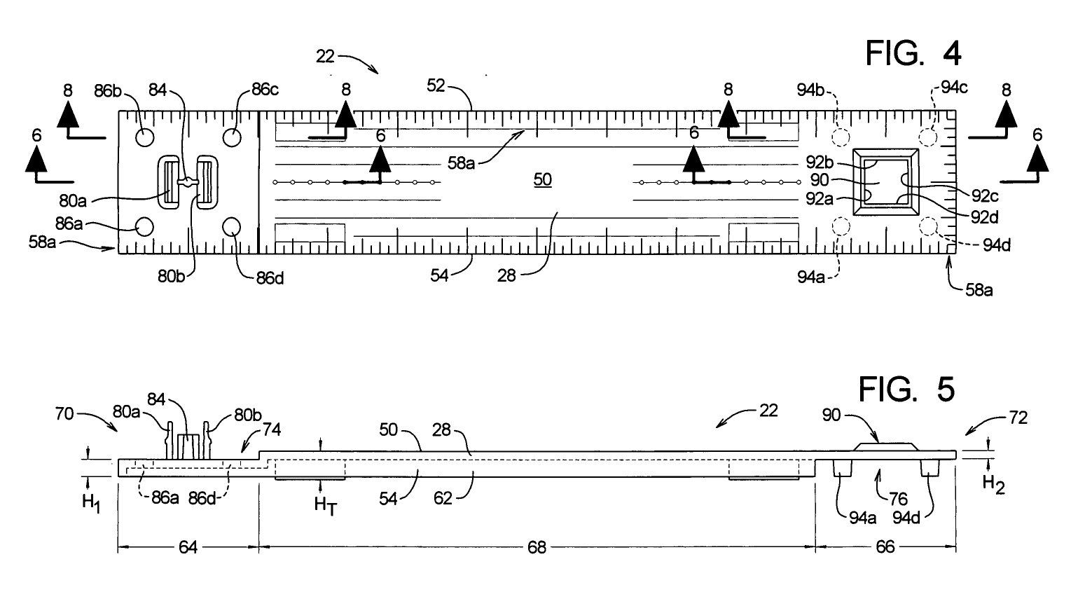

With the foregoing general understanding of the inking assembly 24 in mind, the construction and operation of the example guide system 22 will now be described in further detail. Referring initially to FIGS. 1, 4 and, 5, it can be seen that the guide member 28 defines an exposed surface 50, first and second side edges 52 and 54, an edge surface 56a, an inner surface 56b, and first and second sets of indicia 58a and 58b optionally formed on the exposed surface 50.

During normal use, the edge surface 56a rests on the printing surface 26 and the exposed surface 50 is arranged such that the indicia 58a and 58b are visible to the user. Additionally, the example guide member 28 is optionally made of a clear material such that the printing surface 26 is visible through the guide member 28. Using the example guide member 28, the user may thus view both the indicia 58a and 58b on the exposed surface 50 and the printing surface 26 on the other side of the exposed surface 50.

The optional indicia 58a and 58b may be used to measure, locate, and/or align other devices with the printing surface 26. The first group of indicia 58a takes the form of ruler markings along at least the side edges 52 and 54. The first set of indicia 58a thus may be used to make measurements, such as distances from an edge of a sheet of paper forming the printing surface 26. The second group of indicia 58b takes the form of spaced lines parallel to the edges 52 and 54; these indicia 58b facilitate alignment of the edges 52 or 54 with a line, such as an edge of a sheet of paper, visible below the exposed surface 50.

As perhaps best shown in FIG. 5, the guide member 28 defines first and second side edge surfaces 60 and 62. The side edge surfaces 60 and 62 each define first and second end portions 64 and 66 and an intermediate portion 68. A configuration of the side edge surfaces 60 and 62 between the exposed surface 50 and the edge surface 56a is different in the first end portion 64, the second end portion 66, and the intermediate portion 68.

In particular, FIG. 5 illustrates that the height dimension of the surfaces 60 and 62 in the intermediate portion 68 and the first and second end portions 64 and 66 are referred to as H_{T}, H₂, and H₃, respectively. In the example guide member 28, the height dimension HT is greater than the height dimension H₁, and the height dimension H₁ is in turn greater than the height dimension H₂. In particular, the example height dimensions are related by the following formula:
H_{T}=H₁+H₂ (1).

Although the present invention may be embodied with different relationships between the various height values H_{T}, H₁, and H₂, the relationship described above may be advantageous for reasons that will become apparent from the following discussion.

The exact dimensions of the height values H_{T}, H₁, and H₂ are also not critical but should be selected based on the characteristics of the inking assembly 24 or any other inking assembly that will be used with the guide system 22.

In the example inking system 20, the height value HT is selected to maximize stability of the inking assembly 24 when used in conjunction with the guide system 22. In particular, in the system 20 the height value H_{T} is selected such that the height value H_{T} equal to or greater than the thickness dimension T of the stamp member 36. Expressed as a percentage of the radius dimension R of the stamp member 36, the height value H_{T} is preferably in a first range of between approximately 20% to 75% and should in any event be within a second rage of between approximately 8% to 100%. In the example inking system 20, the height value HT is approximately 44-50% of the radius dimension R of the stamp member 36.

The foregoing parameters allow the ruler side edge surfaces 60 and 62 to engage a relatively large percentage of either the first or second side surfaces 46 and 48 of the wheel assembly 32, thereby improving the ability of the guide system 22 to guide the inking assembly 24 as generally described above.

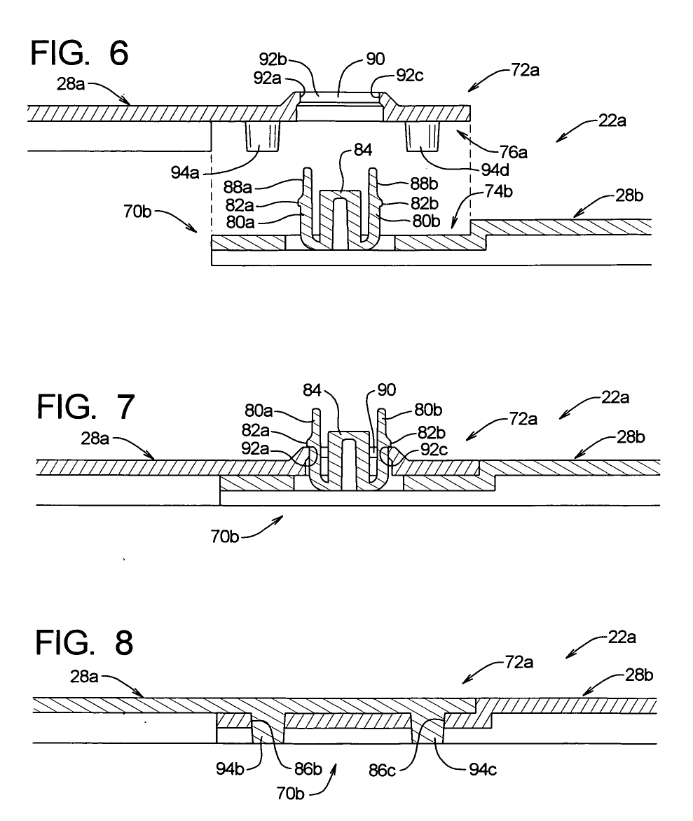

The example guide system 22 is designed to be used with a single guide member 28, as shown in FIGS. 1-3, or, optionally, with a combination of guide members as shown, for example, in FIGS. 6-10. In particular, depicted at 22a in FIGS. 6-9 is a straight combined configuration, while an angled combined configuration is depicted at 22b in FIG. 10.

To allow separate guide members 28 to be combined as shown in FIGS. 6-10, first and second types of attachment portions 70 and 72 are formed on each of the example guide members 28. As will be described in detail below, attachment portions 70 of the first type are adapted to engage attachment portions 72 of the second type to detachably attach two guide members 28 together.

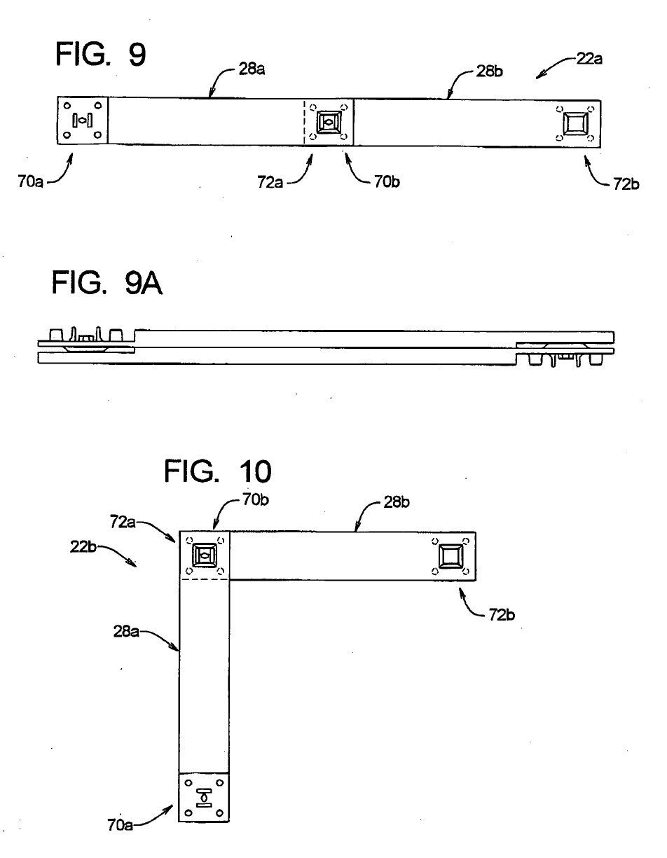

As perhaps best shown in FIGS. 5-8, the first end portion 64 of the guide member 28 forms a first notch portion 74 in the exposed surface 50. Similarly, the second end portion 66 of the guide member 28 forms a second notch portion 76 in the edge surface 56a. The notches 74 and 76 are offset from each other and, as indicated by equation (1) above, complimentary in thickness. Given the relationships among the height values H_{T}, H₁, and H₂ described above, when first and second guide members 28a and 28b are combined in any of the combinations shown in FIGS. 9 and 10, the total height of the combinations 22a and 22b at the attachment portions 70a and 70b is equal to HT. Accordingly, when the attachment portions 70 and 72 are joined to combine two different guide members 28, a substantial portion of the exposed surfaces 50 of the attached guide members 28 are substantially coplanar.

FIGS. 1, 2, 4 and 5 of the drawing illustrate that feet members 78 may be secured to the inner surface 56b of the guide member 28. If used, the feet members 78 engage the printing surface 26 to inhibit relative movement between the printing surface 26 and the guide system 22.

The details of construction and use of the attachment portions 70 and 72 will now be described in further detail with reference to FIGS. 4-8. The first attachment portions 70 comprise detent members 80a and 80b on which are formed detent projections 82a and 82b, respectively, a center post 84 formed between the detent members 80a and 80b, and four alignment holes 86a-d are formed in the guide member 28 in a square pattern centered about the center post 84. Cam surfaces 88a and 88b are formed on the detent members 80a and 80b above the detent projections 82a and 82b, respectively. The detent members 80a and 80b are slightly deformable towards each other.

The second attachment portions 72 comprise a detent opening 90 formed in the guide member 28. The example detent opening 90 is square and is defined by four detent edges 92a-d. Four alignment pegs 94a-d extend from the edge surface 56a in a square pattern centered about the detent opening 90. The pattern of the alignment pegs 94 matches the pattern of the alignment holes 86 described above.

In use, first and second guide members 28a and 28b are displaced relative to each other such that the alignment pegs 94 are aligned with the alignment holes 86 and then such that the detent members 80 enter the detent opening 90. The cam surfaces 88 on the detent members 80 first engage the detent edges 92 to displace the detent members 80a and 80b towards each other. The detent projections 82a and 82b on the detent members 80a and 80b may thus move through the detent opening 90 and past the detent edges 92. At the same time, the alignment pegs 94 enter the alignment holes 86.

When the detent projections 82a and 82b clear the detent edges 92, the detent members 80a and 80b spring away from each other such that the detent projections 82a and 82b engage the detent edges to prevent inadvertent movement of the first guide member 28a relative to the second guide member 28b. The alignment pegs 94 engage the alignment holes 86 to prevent rotation of the guide members 28a and 28b relative to each other.

To separate the first and second guide members 28a and 28b, the cam surfaces 88 of the detent members 80 are pinched together to displace the detent members 80a and 80b towards each other. When the distance between the detent projections 82a and 82b is less than the distance between the opposing detent edges 92 adjacent to the detent projections 82a and 82b, the detent members 80 can be withdrawn from the detent opening 90. At the same time, the alignment pegs 94 are withdrawn from the alignment holes 86.

The attachment portions 70 and 72 of the example guide system 22a allow the guide members 28a and 28b to be placed in any one of four configurations relative to each other. Two of these configurations are illustrated in FIGS. 9 and 10. A third configuration is similar to the configuration shown in FIG. 10, but the first guide member 28a would extend up in FIG. 10 rather than down as shown. As shown in FIG. 9A, the fourth configuration is a storage configuration in which the exposed faces 50 of the guide members 28a and 28b abut each other.

The guide members 28 can be easily formed of plastic using injection molding with the attachment portions 70 and 72 integrally formed thereon. However, other attachment mechanisms can be used by a guide system falling within the scope of the present invention.

The inking system 20 described above can take on many different configurations and can be used in many different ways. Several different examples of configurations of the inking system 20 will now be described. The configurations described herein, including the configuration depicted in FIGS. 1-10, are included as examples only, and the present invention in its broadest form may take on other configurations and may be used in other forms.

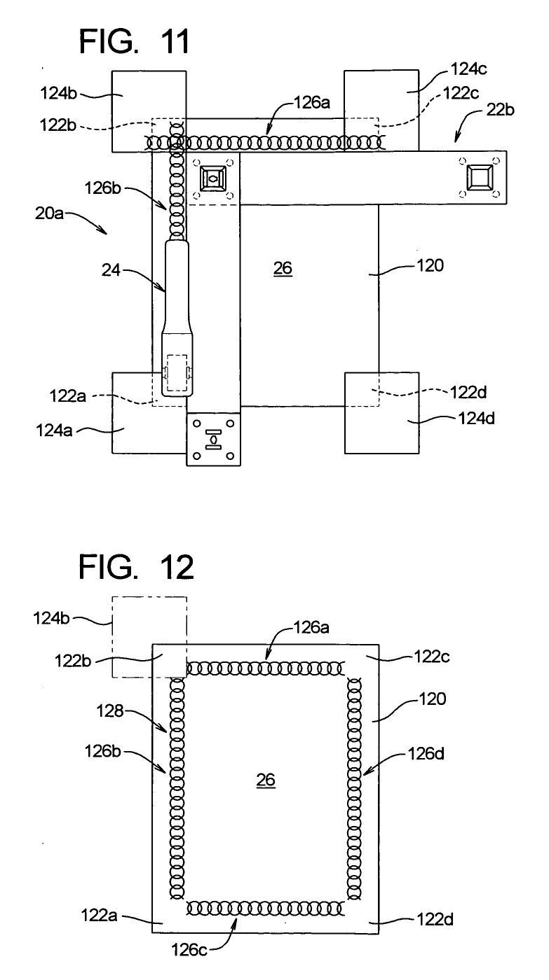

Referring now to FIGS. 11 and 12, depicted therein is another example inking system 20a of the present invention. The inking system 20a comprises the guide system 22 in the third configuration shown in FIG. 10 and the inking assembly 24 described above. The inking system 20a is used to applying ink to a sheet of paper 120 defining four corner portions 122a-d. The sheet of paper 120 defines the printing surface 26. The system 20a further comprises at least one, and in this case four, masking sheets 124a-d symmetrically arranged on the corner portions 122a-d of the paper 120.

The masking sheets 124 are used to mask off the corner portions 122 and the guide system 22 is arranged to extend between first and second sets of adjacent corner portions (122a,122b) and (122b,122c). With the guide system 22 acting as a guide, the inking assembly 24 is then used to form first and second image segments 126a and 126b as shown in FIG. 11. The guide system 22 is then arranged to extend between the third and fourth sets of adjacent corner portions (122a,122d) and (122d,122c) and used to guide the inking assembly to form third and fourth image segments 126c and 126d.

The guide system 22b and masking sheets 124 are then removed as shown in FIG. 12 to reveal a composite image 128 formed by the image segments 126c-d. The image segments 126c-d extend along the borders of the paper 120 but do not overlap in the corner regions 122 because of the removed masking sheets 124.

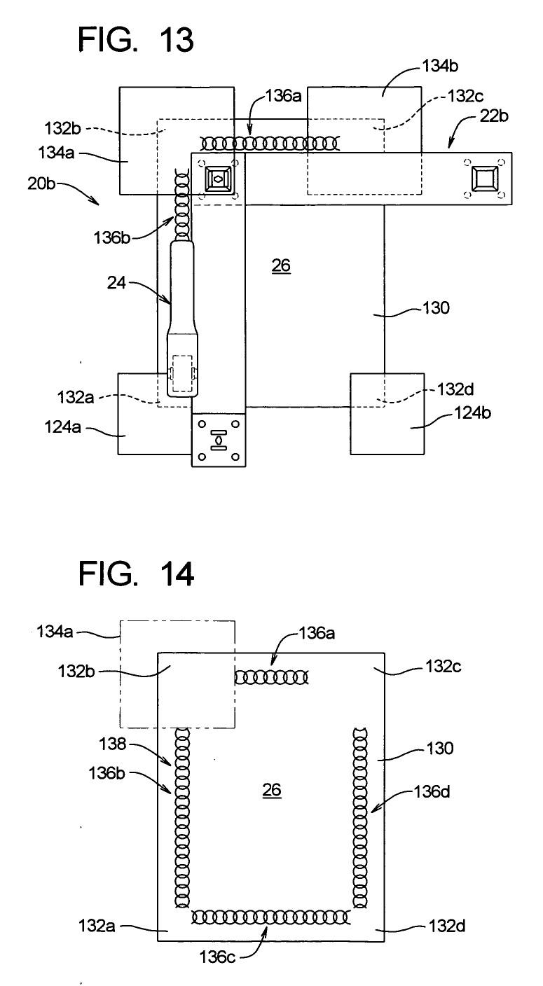

Referring now to FIGS. 13 and 14, depicted therein is another example inking system 20b of the present invention. The inking system 20b comprises the guide system 22 in the third configuration shown in FIG. 10 and the inking assembly 24 described above. The inking system 20b is used to apply ink to a sheet of paper 130 defining four corner portions 132a-d. The sheet of paper 130 defines the printing surface 26. The system 20b further comprises two masking sheets 124a,b as depicted above and two masking sheets 134a,b.

The masking sheets 124 and 134 are used in a manner similar to that described with respect to the system 120 described above. However, the masking sheets 134a,b are larger than the masking sheets 124a,b; the masking sheets 134a,b are applied to the corner portions 132b and 132c such that a larger portion of the corner portions 132b and 132c are masked off than of the corner portions 132a and 132d.

With the guide system 22 acting as a guide, the inking assembly 24 is then used to form first and second image segments 136a and 136b as shown in FIG. 13. The guide system 22 is then arranged to extend between the third and fourth sets of adjacent corner portions (132a,132d) and (132d,132c) and used to guide the inking assembly to form third and fourth image segments 136c and 136d.

The guide system 22b and masking sheets 134 are then removed as shown in FIG. 14 to reveal a composite image 138 formed by the image segments 136c-d. Like the image segments 128 described above, the image segments 136c-d extend along the borders of the paper 130 but do not overlap in the corner regions 132 because of the removed masking sheets 124 and 134.

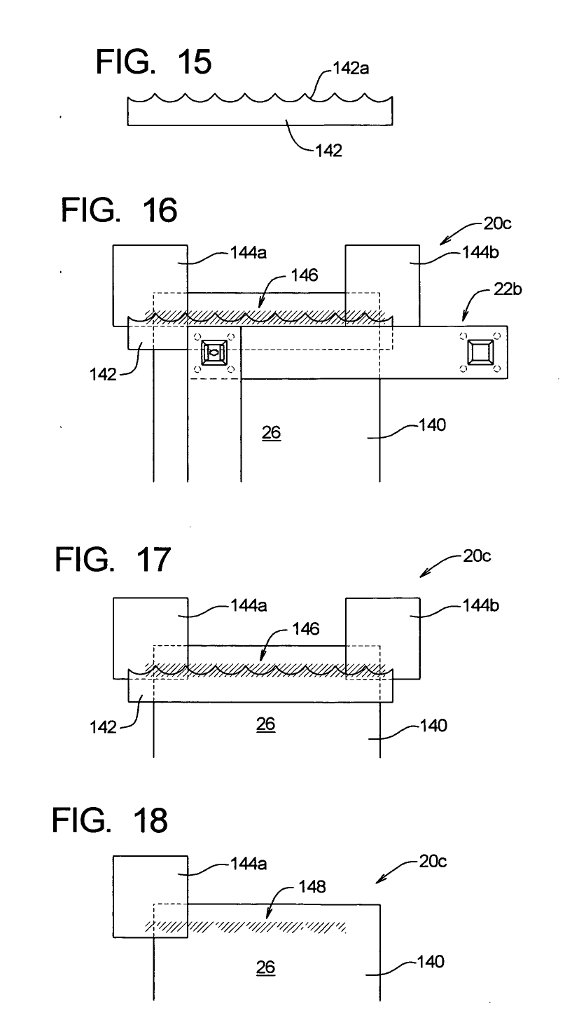

Referring now to FIGS. 15-18, depicted therein is another example inking system 20c of the present invention. The inking system 20c comprises the guide system 22 in the third configuration shown in FIG. 10 and an inking assembly (not shown). The inking system 20c is used to apply ink to a sheet of paper 140. The sheet of paper 140 defines the printing surface 26. The system 20c further comprises an edge masking strip 142 and two masking sheets 144a,b similar to the sheets 124 depicted above.

The masking sheets 144 are used in a manner similar to that described with respect to the system 120 described above. In particular, the masking sheets 144a,b are used to mask off corner portions of the paper 140. In addition, the edge masking strip 142, which defines a shaped edge 142a, is arranged between the masking sheets 144a,b as shown in FIGS. 16 and 17.

With the guide system 22 acting as a guide, the inking assembly is then used to form a full image segment 146, as shown in FIGS. 16 and 17, that extends along the shaped edge 142a between the masking sheets 144a and 144b. The guide system 22b, masking strip 142, and masking sheets 144 are then removed as shown in FIG. 18 to reveal a remaining image 148 formed by the portion of the full image segment 146 not removed with the masking strip 142 and masking sheets 144. As shown in FIG. 18, the inking system 20c allows the formation of continuous images that are not only terminated cleanly, but which can be modified along their entire length by the configuration of the shaped edge 142a.

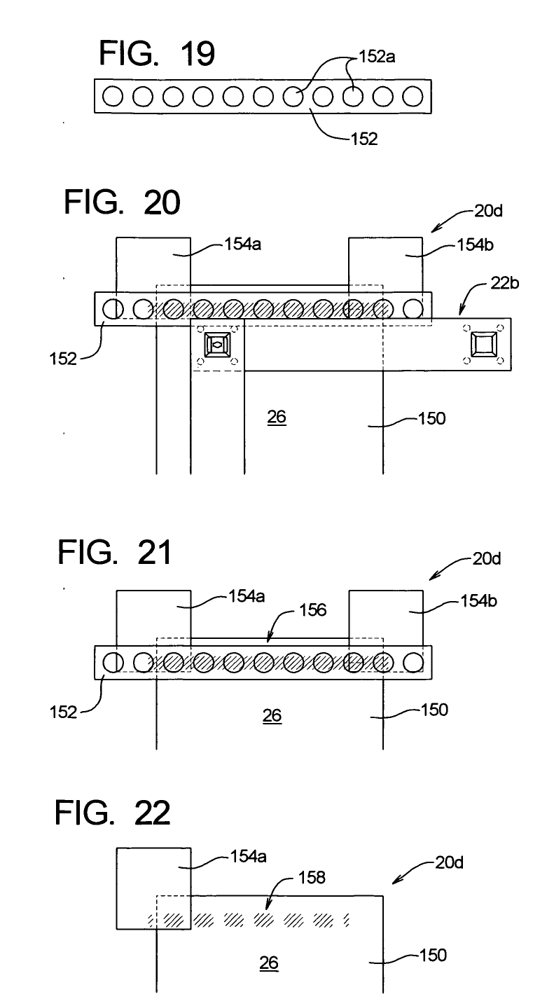

Referring now to FIGS. 19-22, depicted therein is another example inking system 20d of the present invention. The inking system 20d comprises the guide system 22 in the third configuration shown in FIG. 10 and an inking assembly (not shown). The inking system 20d is used to apply ink to a sheet of paper 150. The sheet of paper 150 defines the printing surface 26. The system 20d further comprises a hole masking strip 152 and two masking sheets 154a,b similar to the sheets 124 depicted above.

The masking sheets 154 are used in a manner similar to that described with respect to the system 120 described above. In particular, the masking sheets 154a,b are used to mask off corner portions of the paper 150. In addition, the hole masking strip 152, which defines a series of holes 152a, is arranged between the masking sheets 154a,b as shown in FIGS. 20 and 21.

With the guide system 22 acting as a guide, the inking assembly is then used to form a full image segment 156, as shown in FIGS. 20 and 21, that extends along the hole masking strip 152 between the masking sheets 154a and 154b. The guide system 22b, masking strip 152, and masking sheets 154 are then removed as shown in FIG. 22 to reveal a remaining image 158 formed by the portion of the full image segment 156 not removed with the masking strip 152 and masking sheets 154. As shown in FIG. 22, the inking system 20c allows the formation of continuous images that are not only terminated cleanly, but which can be modified along their entire length by the arrangement of the holes 152a.

Referring now to FIG. 23, depicted therein is another example inking system 20e of the present invention. The inking system 20e comprises the guide system 22 in the third configuration shown in FIG. 10 and an inking assembly (not shown). The inking system 20e is used to apply ink to a sheet of paper 160. The sheet of paper 160 defines the printing surface 26 and first and second corner portions 162a and 162b. The system 20d further comprises two masking sheets 164a,b.

The first and second masking sheets 164a and 164b are similar to the sheets 124 depicted above and are applied to the first and second corner portions 162a and 162b in a similar manner. However, the sheets 164a and 164b are cross-hatched with guide lines 166 that help to align the sheets 164, as well as the guide system 22, with the corners of the paper 160.

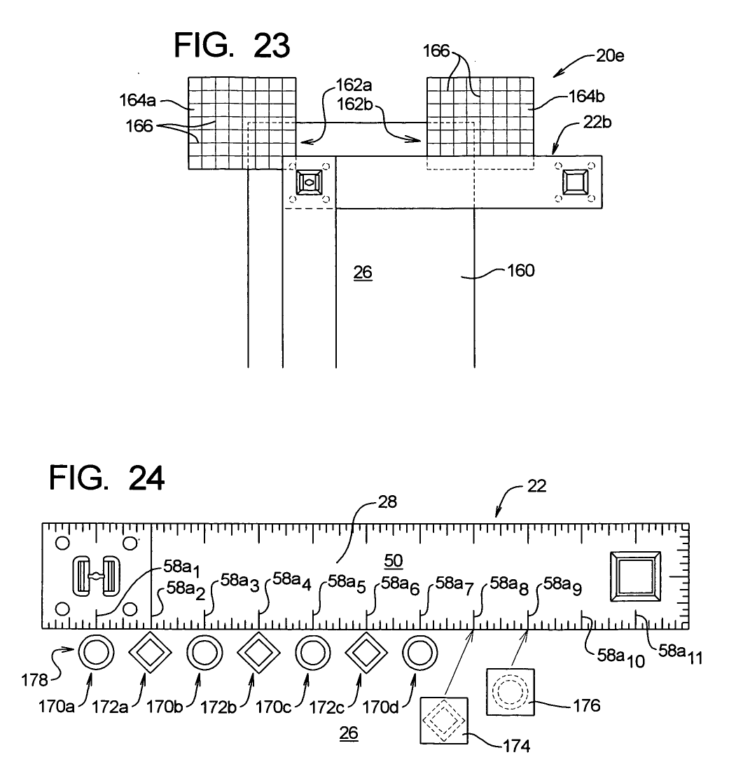

FIG. 24 illustrates that any one of the guide systems described above may be used to facilitate the formation of ink images formed by flat ink assemblies as well as continuous ink assemblies such as the assembly 24 described above. FIG. 24 shows that the guide system 20 formed by the guide member 28 can be used to align discrete images formed by flat inking assemblies. More specifically, FIG. 24 illustrates that ink images 170 and 172 associated with first and second ink stamps 174 and 176 can be formed in equal spaced succession along a straight line.

The first group of indicia 58a takes the form of discrete indicating lines 58a₁₋₁₁, which, as illustrated in FIG. 24, are equally spaced along the length of the guide member 28. In the example shown in FIG. 24, the first stamp 174 is used to form a first round ink image 170a at the first indicating line 58a₁. The second stamp 176 is then used to a first rectangular ink image at the second indicating line 58a₂. This process is repeated as shown until a composite image 178 formed of a desired number of images is formed.

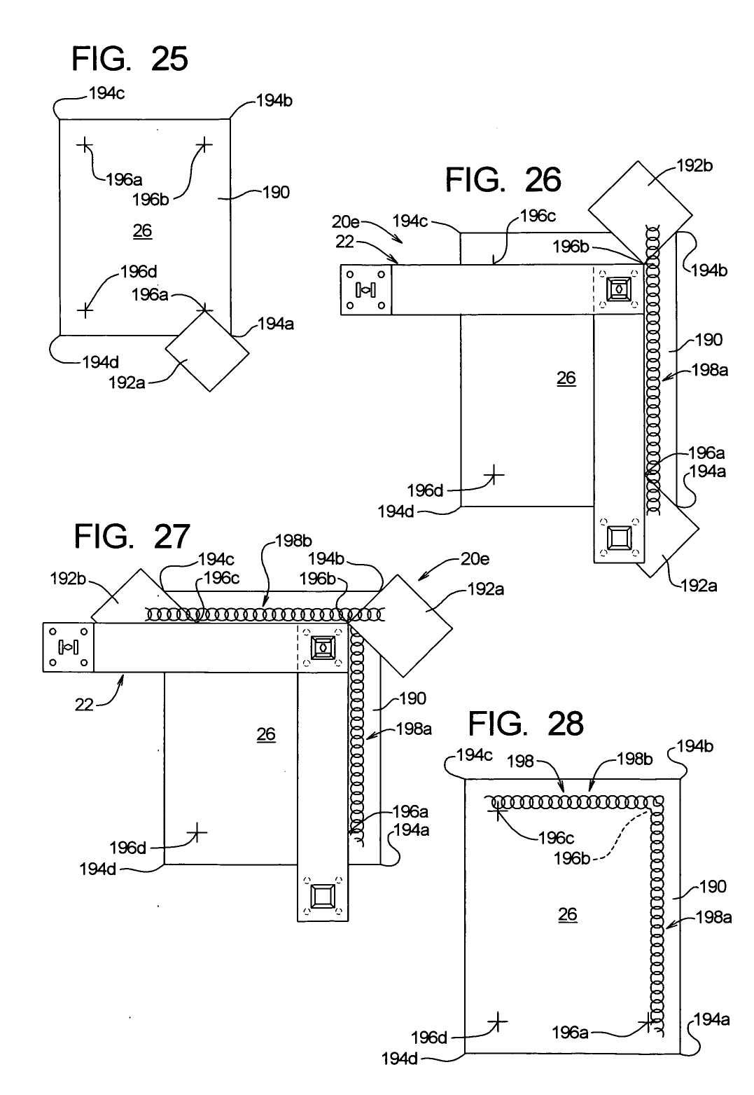

Referring now to FIGS. 25-28, depicted therein is the construction and use of another example inking system 20e of the present invention. The inking system 20e comprises the guide system 22 in the third configuration shown in FIG. 10 and an inking assembly (not shown). The inking system 20e is used to apply ink to a sheet of paper 190. The sheet of paper 190 defines the printing surface 26. The system 20e further comprises two masking sheets 192a,b.

The masking sheets 192a,b are used to mask off portions of the corners 194a,b,c,d of the sheet of paper 190. In particular, as shown in FIG. 25, marks 196a,b,c,d are formed adjacent to each of the corners 194a,b,c,d, respectively. The marks 196 are preferably temporary and may be formed by light pencil marks. The masking sheets 192a,b are arranged between the marks 196a,b and the corners 194a,b; in the example shown in FIGS. 25-28, edges of the masking sheets 192a,b extend at an angle of approximately 45° with respect to the edges of the sheet 190 that intersect at the corners 194a,b.

With the guide system 22 acting as a guide and arranged along the marks 196a,b,c, the inking assembly is then used to form image segments 198a,b, as shown in FIGS. 26-28, that extend along the edges of the sheet 190 between the corners 194a and 194b and between the corners 194b and 194c. The masking sheets 192a,b are repositioned to block out portions of the image segments 198 as appropriate for the desired image. The image segments 198a,b form a composite image 198 as shown in FIGS. 27 and 28.

This process may be repeated along the edges of the sheet 190 between the corners 194c and 194d and between the corners 194d and 194a such that the composite image 198 extends along all four edges of the sheet 190. When the complete image 198 extends along all four edges of the sheet 190, the image segments are terminated at complimentary angles adjacent to the corners 194a,b,c,d that yield a finished, “mitered” look that is aesthetically desirable. When the ink used to form the image 198 is dry, the marks 196 may be removed.

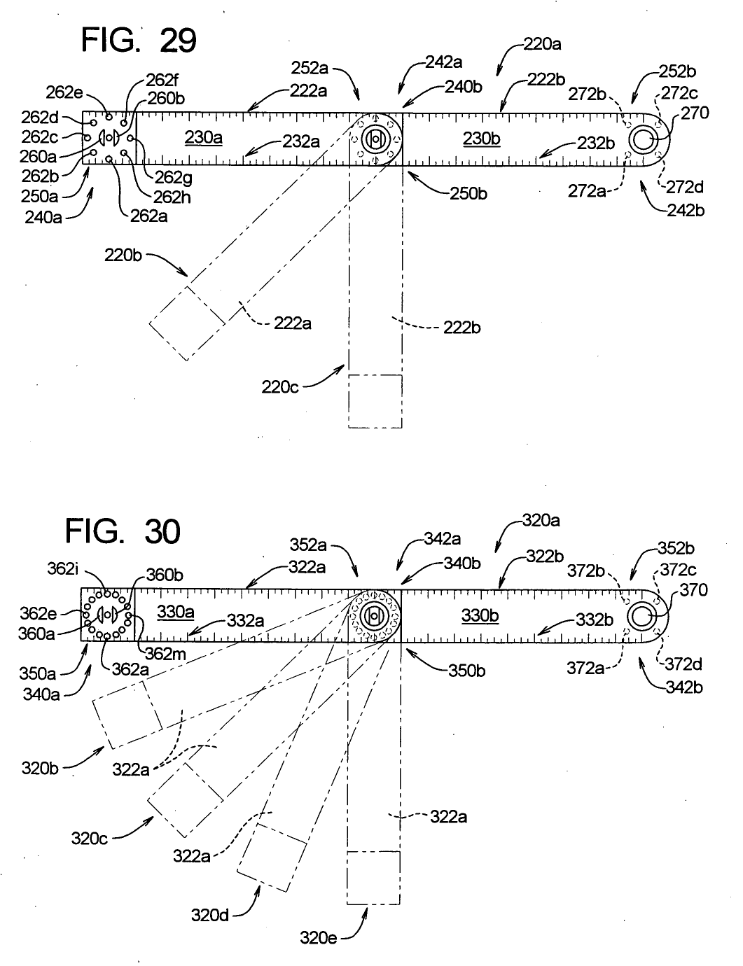

Referring now to FIG. 29, depicted therein is another example guide system 220 that may be used by the present invention. The guide system 220 is shown in solid lines in a first configuration 220a and in broken lines in second and third configurations 220b and 220c. Other configurations of the system 220 are possible as described above with respect to FIGS. 10 and 11.

The guide system 220 comprises a plurality of guide members 222. When used in relation to the guide system 220, the suffixes “a” through “c” are used in FIG. 29 to distinguish among the various configurations in which the system 220 may be placed. The first and second guide members 222a and 222b are identical in the example guide systems 220. The suffixes “a” and “b” are used in FIG. 29 to describe first and second guide members 222a and 222b and the features thereof. Suffixes will be used in the following discussion only when necessary to distinguish among the various configurations of the guide system 220 or to distinguish between the first and second guide members 222a and 222b.

The guide members 222 are similar to the guide member 28 described above in that they each defining an exposed surface 230 on which indicia 232 are formed. The guide members each define a first end 240 and a second end 242.

In addition, like the guide members 28 described above, a first attachment portion 250 is formed on each of the first ends 240, and a second attachment portion 252 is formed on each of the second ends 242. The attachment portions 250 and 252 are similar to the attachment portions 70 and 72 and will be described herein primarily to the extent that they differ from the portions 70 and 72.

The first attachment portions 250 each comprise one or more detent members 260 and a plurality of alignment holes 262. In particular, the attachment portions 250 define eight alignment holes 262 arranged in two square patterns around the detent members 260. In addition, the example detent members 260 are rounded.

The second attachment portions 252 comprise a round detent opening 270 and four alignment pegs 272 arranged in a square pattern matching the square patterns defined by the alignment holes 262.

As shown by comparing the various configurations 220a, 220b, and 220c shown in FIG. 25, it can be seen that the attachment portions 250 and 252 allow additional angles to be formed between the guide members 222a and 222b.

Referring now to FIG. 30, depicted therein is another example guide system 320 that may be used by the present invention. The guide system 320 is shown in solid lines in a first configuration 320a and in broken lines in second, third, fourth, and fifth configurations 320b, 320c, 320d, and 320e. Other configurations of the example guide system 320 are possible as described above with respect to FIGS. 10 and 11.

The guide system 320 comprises a plurality of guide members 322. When used in relation to the guide system 320, the suffixes “a” through “e” are used in FIG. 29 to distinguish among various configurations in which the system 320 may be placed. The example guide system 320 comprises identical first and second guide members 322a and 322b. The suffixes “a” and “b” are used in FIG. 30 to describe the first and second guide members 322a and 322b and the features thereof. Suffixes will be used in the following discussion only when necessary to distinguish among the various configurations of the guide system 320 or to distinguish between the first and second guide members 322a and 322b.

The guide members 322 are similar to the guide member 28 described above in that they each defining an exposed surface 330 on which indicia 332 are formed. The guide members each define a first end 340 and a second end 342.

In addition, like the guide members 28 described above, a first attachment portion 350 is formed on each of the first ends 340, and a second attachment portion 352 is formed on each of the second ends 342. The attachment portions 350 and 352 are similar to the attachment portions 70, 72 and 250,252 described above and will be described herein primarily to the extent that they differ therefrom.

The first attachment portions 350 each comprise one or more detent members 360 and a plurality of alignment holes 362. In particular, the attachment portions 350 define sixteen alignment holes 362 arranged in four square patterns around the detent members 360. In addition, the example detent members 360 are rounded.

The second attachment portions 352 comprise a round detent opening 370 and four alignment pegs 372 arranged in a square pattern matching the square patterns defined by the alignment holes 362.

As shown by comparing the various configurations 320a, 320b, 320c, 320d, and 320e shown in FIG. 30, it can be seen that the attachment portions 350 and 352 allow additional angles to be formed between the guide members 322a and 322b.

The number of angles can thus be increased by employing more alignment holes. As another option, the alignment holes and projections can be replaced with matching grooves and projections that radially extend from an axis defined by the attachment portions. Also, a circular groove with a matching detent projection may be provided to allow the guide members 322a and 322b to extend at any angle within a range of angles. In this case, a screw type apparatus may be used to fix the guide members 322a and 322b in a desired angular relationship.

From the foregoing, it should be apparent that the present invention may be embodied in many different combinations and sub-combinations of the elements and steps described above. The scope of the present invention should thus be determined by the following claims and not the foregoing detailed description.

1. An inking system for forming an ink image on an inking surface, comprising:
a guide system defining at least one side edge surface, where the guide system is arranged in a desired orientation on the inking surface; and
an inking assembly for forming an ink image on the inking surface; whereby
the at least one side edge surface of the guide system is sized and dimensioned to engage the at least one inking assembly such that the ink image is formed at a desired location on the inking surface.

2. An inking system as recited in claim 1, in which the guide system comprises a plurality of guide members.

3. An inking system as recited in claim 2, in which the guide system comprises an attachment system that allows the guide members to be detachably attached.

4. An inking system as recited in claim 3, in which the attachment system allows the guide members to be detachably attached in a plurality of configurations.

5. An inking system as recited in claim 2, in which each of the guide members defines at least one edge surface.

6. An inking system as recited in claim 4, in which each of the guide members defines at least one edge surface, where each configuration defines an angle between the edge surfaces of the guide members.

7. An inking system as recited in claim 4, in which:
the guide members may be detachably attached in first and second configurations relative to each other;
the angle between the edge surfaces is substantially zero degrees when the guide members are detachably attached in the first configuration; and
the angle between the edge surfaces is substantially ninety degrees when the guide members are detachably attached in the second configuration.

8. An inking system as recited in claim 1, in which the inking assembly comprises wheel assembly, where the at least one side edge surface is sized and dimensioned to engage the wheel assembly such that the wheel assembly rolls along a substantially straight inking path.

9. An inking system as recited in claim 8, in which the wheel assembly defines an outer radius, where a height dimension of the at least one side edge surface is within a range of approximately 8% to 100% of the outer radius of the wheel assembly.

10. An inking system as recited in claim 8, in which the wheel assembly defines an outer radius, where a height dimension of the at least one side edge surface is within a range of approximately 20% to 75% of the outer radius of the wheel assembly.

11. An inking system as recited in claim 8, in which the wheel assembly defines an outer radius, where a height dimension of the at least one side edge surface is within a range of approximately 44% to 50% of the outer radius of the wheel assembly.

12. An inking system as recited in claim 8, in which the wheel assembly defines an outer radius, where a height dimension of the at least one side edge surface is approximately 44% of the outer radius of the wheel assembly.

13. An inking system as recited in claim 1, in which the inking assembly comprises at least one flat stamp member.

14. An inking system as recited in claim 13, in which the inking assembly comprises a plurality of flat stamp members.

15. An inking system as recited in claim 8, in which the inking assembly further comprises at least one flat stamp member.

16. An inking system as recited in claim 1, further comprising at least one masking sheet arranged to inhibit formation of the ink image on at least a portion of the inking surface.

17. An inking system as recited in claim 16, in which the masking sheet comprises open portions.

18. An inking system as recited in claim 3, in which the attachment system comprises:
a first type of attachment portion formed on the first guide member; and
a second type of attachment portion formed on the second guide member; whereby
the first attachment portion is adapted to engage the second attachment portion to detachably attach the first and second guide members to form the guide system.

19. An inking system as recited in claim 3, in which the attachment system comprises:
a first attachment projection and a first attachment opening formed on the first guide member; and
a second attachment projection and a second attachment opening formed on the second guide member; whereby
the first attachment projection engages the second attachment opening to detachably attach the first and second guide members to form the guide system in a use configuration; and
the first attachment projection engages the second attachment opening and the second attachment projection engages the first attachment opening to detachably attach the first and second guide members in a storage configuration.

20. An inking system as recited in claim 19, in which the first attachment projection engages the second attachment opening to detachably attach the first and second guide members to form the guide system in a plurality of use configurations.

21. An inking system as recited in claim 3, in which the attachment system comprises a detent projection, a detent opening, an alignment peg, and an alignment opening, where the detent projection engages the detent opening to detachably attach the first and second guide members and the alignment peg engages the alignment opening to align the first and second guide members.

22. An inking system as recited in claim 1, further comprising feet members for engaging the inking surface to inhibit relative movement between the guide system and the inking surface.

23. An inking system as recited in claim 1, in which indicia are formed on the guide system to facilitate location of the guide system with the printing surface.

24. An inking system as recited in claim 23, in which the indicia comprise a group of indicia formed along at least one edge of the guide system for measuring distances.

25. An inking system as recited in claim 23, in which the indicia comprise a group of indicia formed parallel to at least one edge of the guide system for aligning the guide system.

26. An inking system as recited in claim 23, in which the indicia comprise:
a first group of indicia formed along at least one edge of the guide system for measuring distances; and
a second group of indicia formed parallel to at least one edge of the guide system for aligning the guide system.
